(19) United States
(12) Patent Application Publication
(10) Pub. No.: US 2004/0007428 A1
(43) Pub. Date: Jan. 15, 2004

(54) Elevator apparatus

(75) Inventors: Takashi Teramoto, Chiyoda (JP); Naoaki Noguchi, Chiyoda (JP); Atsushi Arakawa, Chiyoda (JP); Atsuya Fujino, Chiyoda (JP)

Correspondence Address: CROWELL & MORING LLP, INTELLECTUAL PROPERTY GROUP, P.O. BOX 14300, WASHINGTON, DC, 20044-4300, US

(73) Assignee: Hitachi, Ltd.

(21) Appl. No.: 10/616,966

(22) Filed: Jul. 11, 2003

(30) Foreign Application Priority Data
Jul. 11, 2002 (JP) 2002-202060
Jul. 17, 2002 (JP) 2002-207672

(51) Int. Cl. B66B 9/00; B66B 11/08; B66B 13/12

(52) U.S. Cl. 187/249; 187/258; 187/319

(57) ABSTRACT

An elevator apparatus comprises two (2) or more sets of elevators with one (1) piece of an elevating passage. Each of the elevators has an elevator car and a hoist, which is connected to the elevator car through a rope. Each the hoist has a sheave, a motor and a brake. The hoist of one of the elevators is projected above the elevator car of the other elevator. Also, open/close doors of the one elevator and those of the other elevator are disposed, so that they shift in front and behind. Door cases of the juxtaposing elevators are disposed to overlap with each other in front and behind.

### BACKGROUND OF THE INVENTION

The present invention relates to an elevator apparatus, and it relates, in particular, to an elevator apparatus, wherein a plural number of elevators are installed within one (1) elevating passage, juxtaposing with each other.

Conventionally, an example is already known of an elevator apparatus, in which two (2) or more sets if elevators are installed juxtaposing with each other, such as, in Japanese Patent Laying-Open No. 2000-351537, for example. With such the elevator apparatus as described in this publication, for the purpose of improving space efficiency of a building, a building wall is provided between the doorways of the two (2) elevators, and elevator control units for each thereof are provided within that building wall.

With such the elevator apparatus as described in Japanese Patent Laying-Open No.2000-351537 mentioned above, for the purpose of reducing a space for installing the elevators, an attention is paid, in particular, on a space for installing the control units of the elevators which are provide juxtaposing with each other. However, with the elevators of high-lift or high-speed, it is desired to reduce, not only the space for installing the control units therein, but also to reduce the space for installing a hoist, which accordingly increases the volume thereof, but in this publication is not paid sufficient consideration on that aspect.

Also, when equipments other than the elevator cars are disposed conventionally, there is a possibility that the juxtaposing elevator cars interfere with each other, in particular, on the door pockets thereof. In the elevator apparatus described in the publication mentioned above, since there is ascertained an enough space for installing the juxtaposing elevators therein, so that each of the elevators operates independently, then no such the drawback will occurs on the doors of the cars. However, the space for installing the elevators must be wider for it.

On a while, when installing the hoists for the elevators, a thin-type hoist having a disk-like motor is mounted on a wall surface of the elevating passage, or a cylinder-like motor is installed at a top or a bottom of the elevating passage. For this reason, with the method of installing the hoists on the wall surface of the elevating passage, the elevating passage must be increased in the cross-section of an area thereof if the hoist is large in the volume thereof. While, with the method of installing the hoist on the bottom of the elevating passage, there is necessity of providing pulleys for hanging up the cars by means of a rope at the top of the elevating passage, as well as, suspending the rope from the hoist to the pulley at the top. As a result of this, if the lift is higher, the length of the rope to be suspended around is also longer, and therefore it brings bout a vibration of the car, which is caused due to plasticity of the rope. With the elevator of high-lift or high-speed, from the reason mentioned above, the hoists are mounted directly within a top portion of the elevating passage, or within a machine room which is provided separately from the elevating passage, however it is desired to make the machine room small.

### BRIEF SUMMARY OF THE INVENTION

An object according to the present invention, which is achieved by paying attention on such the drawbacks of the conventional arts, mentioned above, is to ascertain an area occupied by the elevator cars, within an elevator apparatus in which a plural number of elevators are installed juxtaposing with each other. Other object according to the present invention is to reduce the area for installing the elevator cars therein. Further other object according to the present invention is to achieve a retrofitable elevator apparatus, in which two (2) sets of elevators can be installed within a space for one (1) set of elevator. Further other object according to the present invention is to achieve the elevator apparatus, with which a number of parts can be reduced down and thereby simplifying the installation work thereof. According to the present invention, an object thereof is to achieve at least one of those objects mentioned above.

According to the present invention, for accomplishing any one of the above objects, first of all, there is provided an elevator apparatus, comprising: a plural number of elevators, being disposed juxtaposing with each other, each of said elevator having, an elevator car, and a hoist, being connected to said elevator car through a rope, wherein the hoist of one of said elevators is protruded above the elevator car of the other elevator, or wherein a perpendicular projection of the hoist of one of said elevators has a portion overlapping on a perpendicular projection of the elevator car of the other elevator.

Also, according to the present invention, for achieving the object mentioned above, there is provided an elevator apparatus, providing a plural number of elevators juxtaposing with each other within an elevating passage, wherein positions of an open/close door portion of one of the elevators and an open/close door portion of the other of the elevators are set into a relationship of busing on positions in front and behind.

Further, according to the present invention, for achieving the object mentioned above, there is also provided an elevator apparatus, having a plural number of elevators provided juxtaposing with each other within an elevating passage, each elevator having an elevator car and a hoist, which is connected to the elevator car through a rope, wherein the hoist of one elevator projects above the elevator car of the other elevator, and comprising a hall side door guidance groove for allowing an open/close door of the one elevator to project to a side of the other elevator when said open/close door opens.

### BRIEF DESCRIPTION OF THE SEVERAL VIEWS OF THE DRAWING

FIG. 1 is a block diagram of an elevator apparatus, according to one embodiment of the present invention;

FIGS. 2 and 3 are an upper cross-section view and a side cross-section view of the elevator apparatus shown in FIG. 1;

FIG. 4 is a block diagram of the elevator apparatus, according to other embodiment of the present invention;

FIGS. 5 to 11 are upper cross-section views of the elevator apparatus, according to various embodiment of the present invention; and

FIG. 12 is a view for explaining a door portion of an elevator, which was shown in FIG. 2.

### DETAILED DESCRIPTION OF THE INVENTION

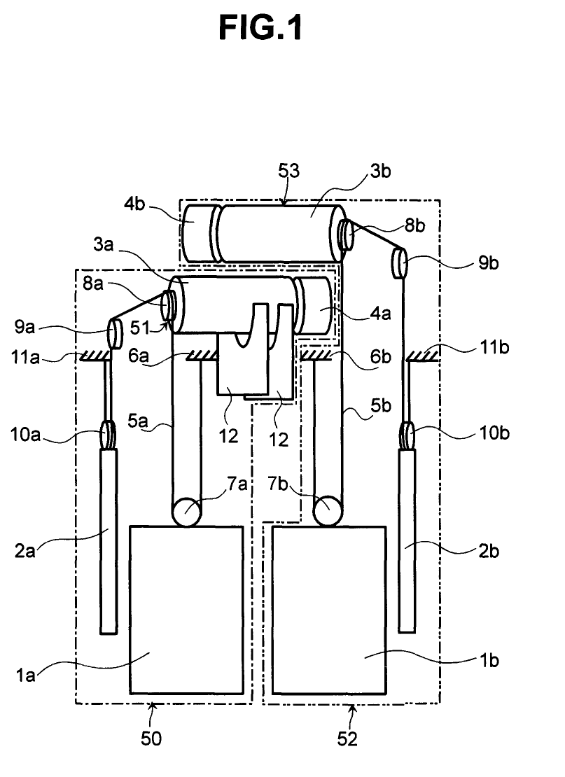

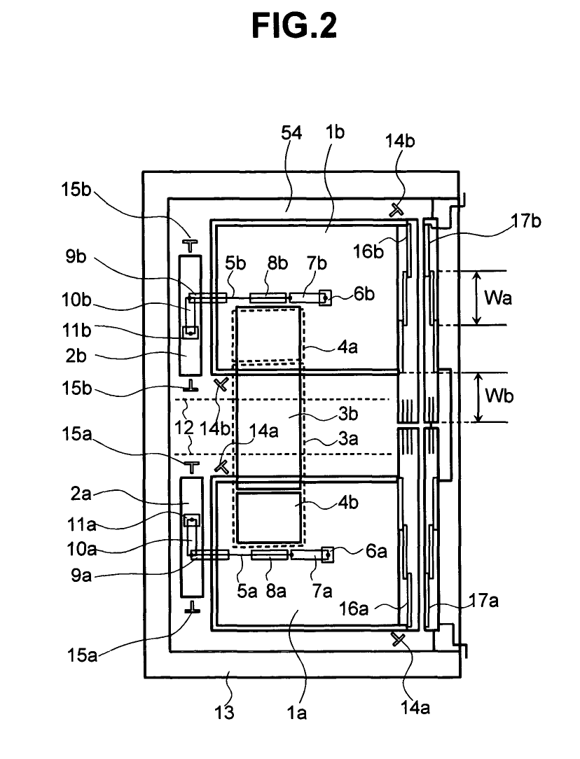

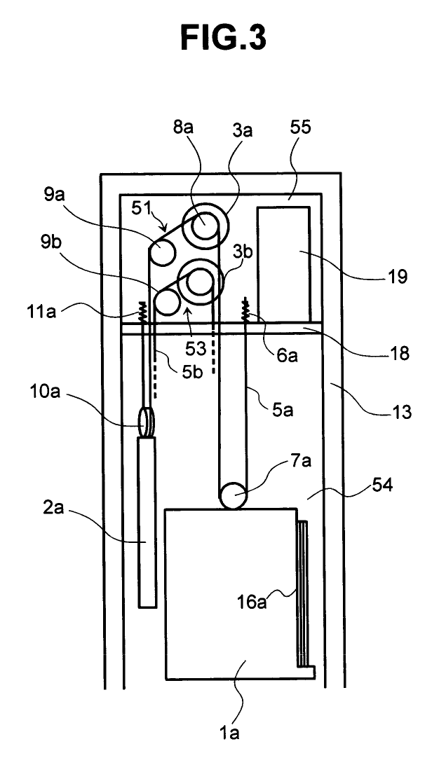

Hereinafter, several embodiments according to the present invention will be fully explained by referring to the attached drawings. FIGS. 1 to 3 show the elevator apparatus, according to an embodiment of the present invention, and in particular, FIG. 1 shows the block diagram, FIG. 2 the upper cross-section view, and FIG. 3 the side cross-section view thereof. In FIG. 1, two (2) sets of elevators 50 and 52 are provided juxtaposing with each other within an elevating passage not shown in the figure. The two (2) elevators are almost same in the structure thereof, and therefore explanation will be made only on an elevator A50.

The elevator A 50 has an elevator car la, and on an upper surface of the elevator car 1a is attached a pulley 7a on elevator car side. On this pulley 7a, a rope 5a is suspended around, which is fixed at one end thereof onto a fixing portion 6a of elevator car side. After being suspended around the elevator car side pulley 7a, the rope 5a is then suspended around a sheave 8a equipped with a hoist 51, which is fixedly mounted within a machine room 55, being provided in the vicinity of a top portion of an elevating passage 54. And after the sheave 8a, it is changed in the direction thereof by means of a bending wheel 9a, to be suspended round a counter weight side pulley 10a, which is fixed in an upper portion of a counter weight 2a, and thereafter the rope 5a is fixed onto a counter weight side rope-end fixing portion 11a at the other end thereof. Herein, the hoist 51 has a motor 3a, a brake 4a attached onto a shaft end of the motor 3a, the sheave 8a, which is attached on the motor shaft at the opposite side of the brake 4a, and the bending wheel 9a. However, the bending wheel 9a may be unnecessary, depending on the position of the sheave. Also, a protection fence 12 is provided below the motor 3a.

Also, the structure of the elevator B52 is almost same to that mentioned above. With the elevator apparatus 50 and 52 constructed in this manner, the ropes 5a and 5b moves when the motors 3a and 3b of the hoists 51 and 53 are driven, and accompanying with this, the elevator cars 1a and 1b and the counter weights 2a and 2b moves up and down. When accommodating two (2) sets of the elevator devices within one (1) piece of the elevating passage 54 in this manner, it is necessary to use a space of the elevating passage 54 practically. Then, according to the present embodiment, a portion of the hoist 51 of the elevator A 50 and a portion of the hoist 53 of the elevator B 52 are made to protrude above the other elevator cars 1b and 1a, respectively. Further, the hoist 52 is positioned above the hoist 51. Further, the volumes of the motors 3a and 3b of the hoists 51 and 53 and the brakes 4a and 4b increase in accordance with high-lifting and high-speeding of the elevator 50 and 52. An amount of the protrusion of the hoist also increases.

The upper cross-section view is shown in FIG. 2, in particular, of the elevator apparatus shown in FIG. 1. A portion of a perpendicular projection of the motor 3a lies on the perpendicular projection of the elevator car 1a. Also, a portion of the perpendicular projection of the motor 3b lies on the perpendicular projection of the elevator car 1b. A portion of the perpendicular projection of the brake 4a lies on the perpendicular projection of the elevator car 1b, and a portion of the perpendicular projection of the brake 4b lies on the perpendicular projection of the elevator car 1a. A portion of the perpendicular projection of the motor 3a lies on the perpendicular projection of the motor 3b and the brake 4b. A portion of the perpendicular projection of the motor 3b lies on the perpendicular projection of the motor 3a and the brake 4a.

The counter weight 2a is guided by means of a pair of counter weight rails 15a, which are disposed in parallel with each other, thereby to freely move but only in the vertical direction. In the similar manner, the counter weight 2b is guided by means of a pair of counterweight rails 15b disposed in parallel with. The elevator car 1a is guided by means of a car rail 14a, which is disposed at a diagonal portion on an outer peripheral portion of the elevator car 1a, thereby to freely move only in the vertical direction.

Similarly, the elevator car 1b is guided by means of a car rail 14b. The reason why the car rails 14a and 14b are disposed at the diagonal position lies in that supporting rigidity thereof can be risen up when the car rails 14a and 14b support the wall 13, and thereby to bring the car rails 14a and 14b near to the wall 13 of the elevating passage. Conventionally, a supporting beam is provided in a gap defined between the cars for supporting the rails provided between the juxtaposing cars, when a plural number of elevator cars are disposed juxtaposing with each other, however according to the present embodiment, the supporting beam is not necessary.

A left-hand side cross-section view is shown in FIG. 3, in particular, of the elevator apparatus shown in FIG. 1. From this side view, it is clear that the motor 3a and the motor 3b are disposed at the positions, so that they overlap with each other vertically. Both of those motors 3a and 3b are positioned above the car la. The hoists 51 and 53 are supported by supporting beams 18, which are attached in the front surface and the rear surface of the wall 13 of the elevating passage 54. According to the present embodiment, a space being defined upper than the supporting beams 18 is used in a form of a machine room 55. Further, in FIG. 3, a control panel 19 for controlling the motors 3a and 3b is provided within the machine room 55, which is provided above the elevating passage 54.

The control panel 19, the motors 3a and 3b, the brakes 4a and 4b, and the sheaves 8a and 8b must be conducted with maintenance periodically. During the maintenance operation, since the cars being subjected under the maintenance operation move sometimes, erroneously, therefore it is often to conduct the operation from an upper portion of the juxtaposing elevator cars. In this case, there maybe a possibility that a worker falls down into the elevating passage accidentally if the worker thrusts out his body from the juxtaposing car. Then, according to the present embodiment, at the top of the elevating passage 54 is provided the protection fence 12 for dividing the space of elevating passage 54, thereby protecting the worker from falling down therein.

According to the present embodiment, it is possible to install the hoists, each having a relatively large volume, within the elevating passage or the machine room located in an upper portion of the elevating passage. When disposing the two (2) sets of hoists for the juxtaposing elevators piling up each other, much space is needed for installing the hoists in the vertical direction. However, since in a building in which the high-lift elevators are installed, mostly there are still enough room in the space, in particular in the vertical direction, therefore the present embodiment can be applied easily. However, if a requirement is made on shortening the size of the machine room in the vertical direction, it can be deal with, for example, by designing the motors 3a and 3b and the brakes 4a and 4b to be long in the size and small in the diameter thereof.

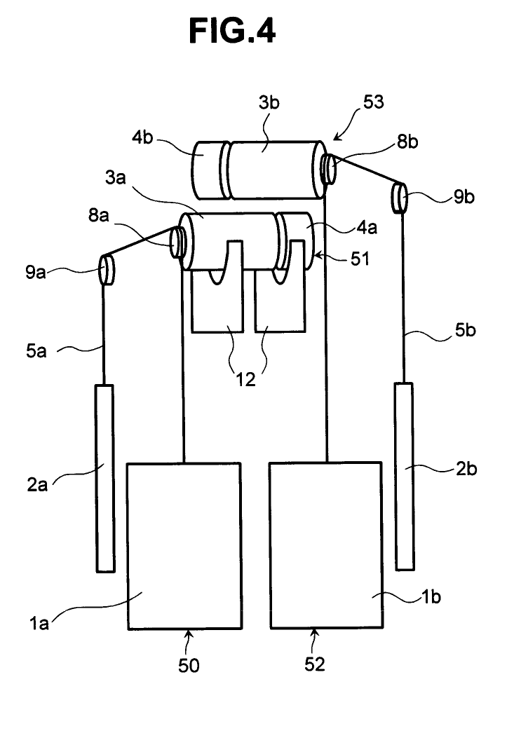

A diagram is shown in FIG. 4, of other embodiment according to the present invention. The present embodiment differs from the embodiment mentioned above, in particular, in an aspect of omitting the pulleys of the elevator car side and the counterweight side. Since those two (2) kinds of pulleys are omitted, the one end of the ropes 5a or 5b are fixed directly onto the elevator cars 1a and 1b, while the other ends thereof are fixed to the counter weights 2a or 2b. According to the present embodiment, the equipments can be simplified. However, comparing to the embodiment shown in FIG. 1, the rotation speed required to the motors 3a or 3b comes down to be a half (1/2), but the torque generated by the motor 3a or 3b rises up two (2) times larger. Accordingly, large-diameter motors are necessary for the motors 3a and 3b, which can produce large torque therefrom. The present embodiment is preferable, in particular, in the case where there is enough room in the space for installing the hoists therein and there is strong necessity of simplifying the structures of the equipments thereof.

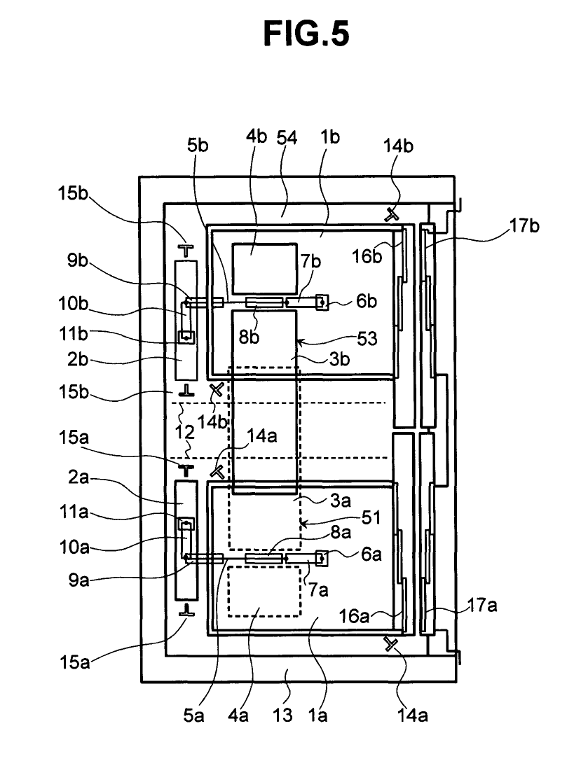

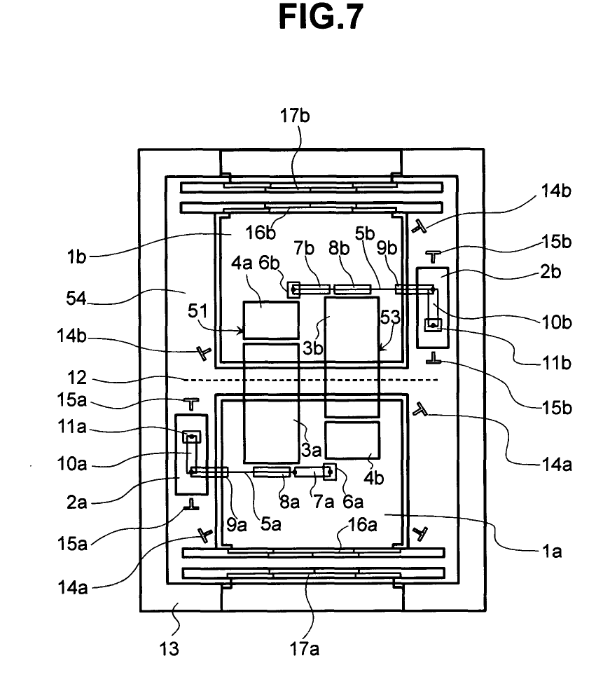

Further several embodiments according to the present invention will be shown in FIGS. 5 to 7. Any one of those figures is an upper cross-section view. The difference of the embodiment shown in FIG. 7 from that shown in FIG. 2 lies in that relative positions of the hoists 51 and 53 are changed. The brake 4a of the hoist 51 for the elevator A is disposed above the elevator car la, and a tail portion of the motor 3a is protruded until it reaches to the position above the elevator car 1b of the elevator B, while putting the space occupied by the elevator car side pulley 7a and the rope 5b therebetween. In the similar manner, a tail portion of the motor 3b of the elevator B is protruded until it comes up to the position above the elevator car 1a.

Namely, it is so done that the perpendicular projections of the brakes 4a and 4b lies on the perpendicular projections of their own elevator cars 1a and 1b, respectively. On a while, the perpendicular projections of the motors 3a and 3b, differing from those shown in FIG. 2, overlap with each other in a portion thereof, and with the hoists 51 and 53, the perpendicular projections thereof overlap with each other, partially. According to the present embodiment, since the distances between the sheaves 8a and 8b and the brakes 4a and 4b are made short, the torsion deformation can be made small on a shaft connecting between the sheave and the brake, thereby reducing a shock occurring when actuating the brake.

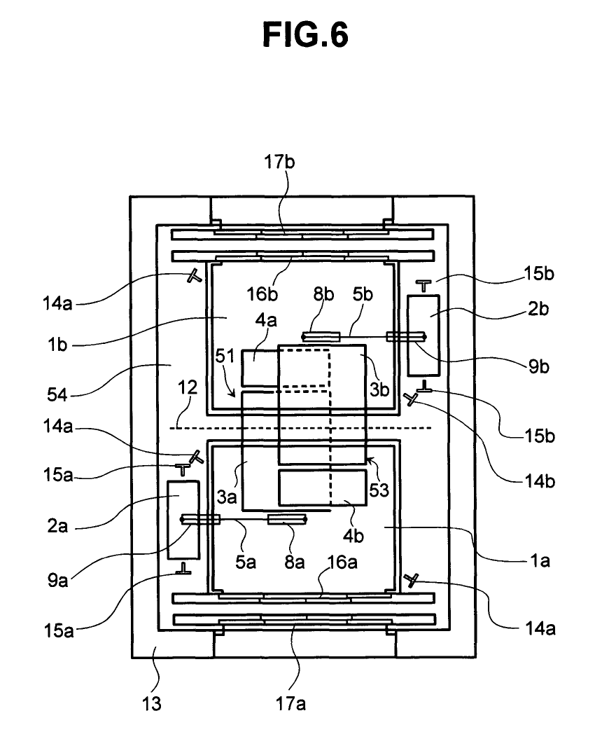

In the embodiment shown in FIG. 6, differing from the embodiment shown in FIG. 2, the elevator A and the elevator B are provided back to back. An elevator car door 16a and a hall door 17a of the elevator A, and an elevator car door 16b and a hall door 17b of the elevator B are provided on the opposite wall surfaces of the elevating passage 54. Since the elevator cars 1a and 1b are provided back to back, the counterweights 2a and 2b are disposed on the side surface of the elevator cars 1a and 1b of the respective elevators. Also, omitting the elevator car side pulley and the pulley of the counterweight, one end of the rope 5a or 5b is fixed directly to the elevator car 1a or 1b, while the other end thereof to the counterweight 2a or 2b, respectively. Further, the perpendicular projections of the hoists 51 and 53 are shifted with each other, in the horizontal direction.

According to the present embodiment, it is possible to make two (2) elevators received within one (1) elevating passage, even in such a layout of a building where two (2) sets of elevators cannot be positioned therein. Since the hoists 51 and 53 are changed in the position, in particular, the perpendicular projection thereof, then it is possible to reduce the space where the hoists are installed.

With the embodiment shown in FIG. 7, being similar to that shown in FIG. 6, two (2) sets of the elevators are positioned back to back. However, differing from the embodiment shown in FIG. 6, the perpendicular projections of the hoists 51 and 53 are shifted with each other, completely. Further, each elevator has an elevator car side pulley 7a or 7b, and a counterweight side pulley 10a or 10b. Since the installing position of the hoist 51 or 53 is shifted to the left-hand side or the right-hand side from a center of the elevator car 1a or 1b, therefore the perpendicular projections of the motors 3a and 3b and the brakes 4a and 4b will not overlap with each other. However, in FIG. 7, both the hoists 51 and 53 are positioned at the same place in the vertical direction thereof.

According to the present embodiment, it is possible to reduce the space for installing the hoists therein. Also, since it is possible to accommodate the both motors 3a and 3b within the same machine room, the hoists can be mounted at a top portion of the elevating passage, even if they are relatively large. With this, it is possible to improve utilizing efficiency of the space, in particular, in an upper layer portion of a building. Also, mounting the hoists on the same base enables installation of the hoists with cheap and easy structure. Further, it is also possible to conduct the maintenance work for the hoists from the position on the elevator cars juxtaposing with each other, with safety, and thereby shortening the time for maintenance thereof.

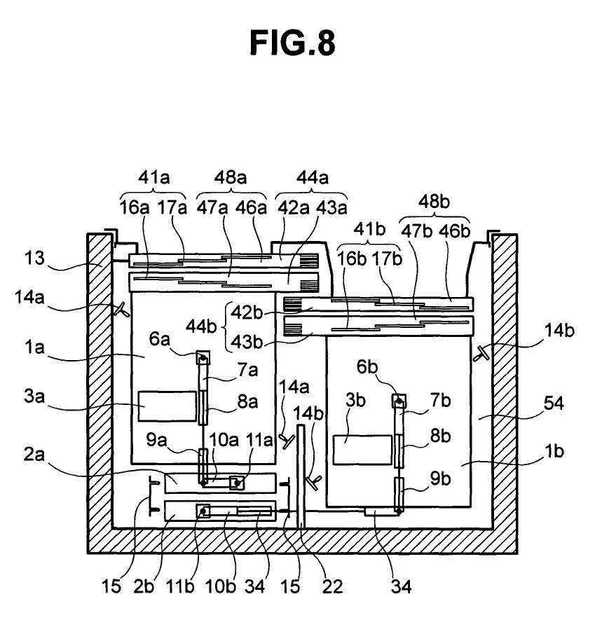

Other embodiment according to the present invention will be shown in FIG. 8 and thereafter. The elevator A and elevator B are accommodated within the elevating passage 54, which is surrounded by the elevating passage walls 13. In the instance, the elevator car 1a of the elevator A and the elevator car 1b of the elevator B are changed in the positions thereof a little bit, in the direction of front and behind. Since the two (2) sets of elevator cars 1a and 1b are received within the elevating passage 54, door cases 44a and 44b are disposed in front and behind with each other, for receiving the doors 41a and 41b therein, which open and close in the horizontal direction on the paper surface of FIG. 8, thereby effectively achieving practical utilization of an area, in particular, in front of the elevating passage 54. If bringing the length to be same between the elevator A and the elevator B in the direction of front and behind, though it is possible to keep a space in the rear surface of the elevator car 1a of the elevator A, the car of which locates at the front side thereof, however it is impossible to keep a sufficient space on the rear surface side of the elevator car 1b of the elevator B for disposing other parts thereof. Then, also the counterweight 2b of the elevator B is guided to the rear surface side of the elevator car 1a.

Further, for the purpose of elevating the elevator car 1b, turning pulleys 34 are disposed in a plural number of pieces thereof within a moving passage of the rope 5b. At the lower end of the rope suspended on those pulleys, the counterweight 2b is attached for holding the pulley 10b. The counterweight 5b is disposed on the rear surface of the counter weight 5a.

With such the present embodiment constructed in this manner, since the turning pulleys 34 are provided, the elevating passage 54 is increased in the size in the direction of height thereof. However, in such a high-rising buildings where there is a big demands for the elevators, since there is room in the size of the direction of height, such the aspect mentioned above can be escaped from. Further, the motors 3a and 3b and the turning pulleys 34 may be disposed in the direction, being oblique or perpendicular, depending on the shape and/or the cross-section area of the elevating passage 54.

Next, explanation will be given on a door portion. If aligning the door cases 44a and 44b, being necessary for receiving the doors 41a and 41b of the elevators A and B therein, on the same straight line, an effective space is reduced in the horizontal directions of the elevator. Then, according to the present embodiment, the doors on both sides are shifted in front and behind each other. Namely, the doors 41a and 41b are so disposed, that the door case 44a of the elevator A comes on the front surface of the door case 4b of the elevator B, at about the central portion of the front surface side of the elevating passage 54. The door 41a of the elevator A opens from the left-hand side end to the center, while the door 41b of the elevator B opens from the right-hand side end to the center.

For the purpose of shortening the distance in setting of the juxtaposing elevator cars 1a and 1b, guide grooves are avoided from interfering with each other, which are positioned at a lower end or an upper end of the door cases 44a and 44b attached in front of the elevator cars 1a and 1b, with such the structure as was mentioned in the above. Further, in FIG. 8, both the elevators A and B have doors 41a and 41b, each having three, (3) pieces thereof. Each of the doors are duplicated; i.e., the door on the elevator car side and the door on the hall side. As a result of this, the elevator A has three (3) pieces of the doors 16a on the elevator car side, and three (3) pieces of the doors 17a on the hall side, and the guide groove 47a is provided on the elevator car side while the guide groove 46a on the hall side. Also, the door case 43a is disposed on the elevator car side, and the door case 42a on the hall side. This is also same to the elevator B.

The elevator car 1b is disposed behind the elevator car 1a, keeping a distance therebetween, at least, adding the distance between the two (2) grooves 46b and 47b to the width of the guide groove 46b on the elevator car side and the width of the door guide groove 47b on the hall side. Since the elevator car 1b is disposed behind the elevator car 1a, the door guide groove 46b is also positioned at the rear side by shifting a distance, at which the elevator car 1b is shifted. Further, the elevator car 1b is positioned as close to the elevating passage 13 as possible, to reduce the distance between the elevator car 1b and the wall 13 of elevating passage, thereby utilizing the space of the elevating passage 54, practically. For this reason, under the condition when the door groove 46b on the hall side is shifted behind, the door groove 46b is fixed on the wall 13 of elevating passage by using, such as, a member of L-like shape attached on the wall 13 of elevating passage, not shown in the figure, for example.

Since the elevator car 1b of the elevator B is shifted behind, there is no space remaining on the rear side of the elevator car 1b. However, on the rear surface of the elevator car 1a of the elevator A can be defined a space by shifting the elevator car 1b behind. Then, the counterweights 2a and 2b for the two (2) sets of the elevators are disposed in such the manner as was mentioned in the above. According to the present embodiment, since the elevators A and B are assumed to be the same, the counterweights 2a and 2b are also same to each other in the size of width thereof. Then, a pair of rails 15 on the left-hand side and the right-hand side is formed, by forming the rails for those counterweights in one body. This rail 15 can be manufactured, for example, by forming steel plate into a shape having plural steps through the roll forming, or using a press one-piece molding through drawing. According to the present embodiment, it is possible to reduce the installation time necessary for installing the rails 15, which is long in the length and is required to be installed at high accuracy.

When installing the elevators juxtaposing with each other, conventionally, support beams 22 are provided extending from the rear side to the front side of the elevating passage 54, at a predetermined distance therebetween, in the direction of height of the elevating passage of the gap, which is defined by the juxtaposing elevator cars 1a and 1b, thereby supporting the elevator car rails 14a and 14b. According to the present embodiment, due to the structure that the door cases 44a and 44b lie on each other in the direction of front and behind the elevating passage 54, it is impossible to extend the support beams 22 up to the front surface of the elevating passage 54. Then, the support beams 22 are extended from the elevating passage 54 on the rear side thereof in a cantilever-like manner. Further, the elevator car rails 14a and 14b are provided inclining to the elevator cars 1a and 1b, and they are disposed symmetrically on both sides, in the width direction of the elevating passage 54.

According to the present embodiment, since the two (2) pairs of the elevator car rails 14a and 14b are supported at the locations relatively near to the wall 13 of elevating passage, therefore it is possible to support the weight of the entire elevators, easily. Also, since the plural number of elevator car rails 14a and 14b and the counterweight rail 15 are attached by means of one (1) piece of a part not shown in the figure, it is possible to reduce the number of parts.

Though the elevator B is shifted behind in the embodiment mentioned above, however it is also possible to shift behind any one of the juxtaposing elevators. Also, since there is a possibility that a passenger is blocked in her/his view by the door 41a of the elevator car 1a of the elevator A, when she/he comes out into the hall from the elevator car 1b of the elevator B, which is shifted behind, it is preferable to provide a design having an inclination. Further, according to the present embodiment, it is also possible to reduce the distance for setting the juxtaposing elevator cars therein, at the most, by the length of the door case for one (1) set.

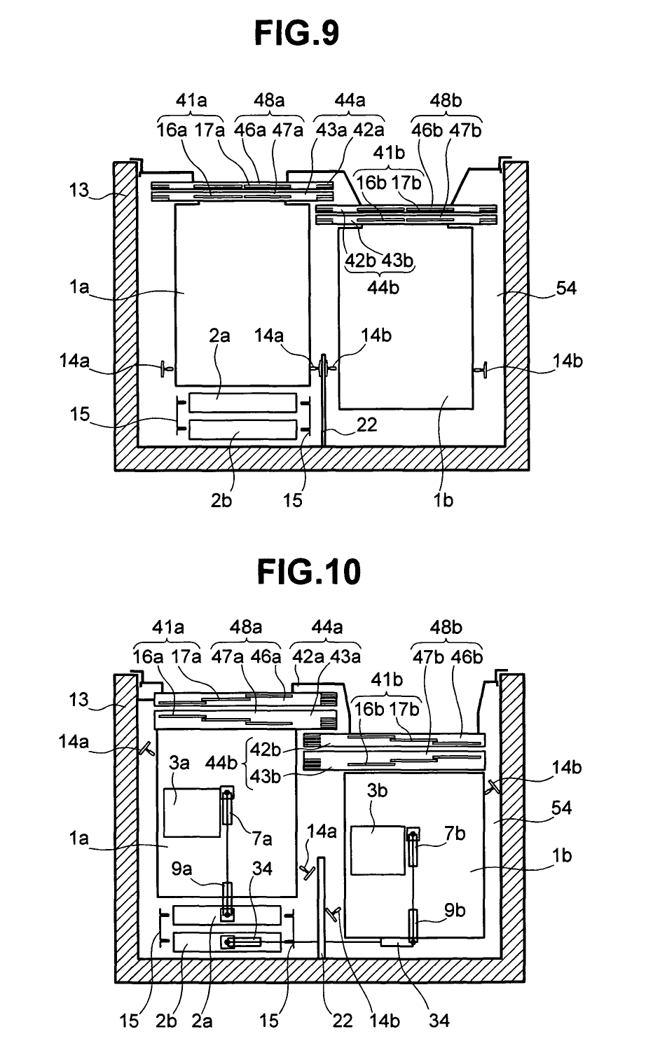

Other embodiment of the elevator apparatus according to the present invention will be shown in FIG. 9. The feature of the present embodiment, differing from that shown in FIG. 8, leis in that the doors 41a and 41b on the elevator car side and the hall side adopt doors, each of which opens directing from the center to the both sides of the each elevator in both the elevator A and the elevator B. In the similar manner to the embodiment mentioned above, the door cases 44a and 44b overlap each other in the direction of front and behind the elevating passage 54, each of which receives the right-hand side door of the elevator A or the left-hand side door of the elevator B therein. With this, it is possible to narrow the distance between the juxtaposing elevator cars 1a and 1b. According to the present embodiment, comparing to the embodiment mentioned above, it is possible to narrow the width of the door guide grooves 48a and 48b, thereby to make an amount of shifting the elevator B behind small. However, the pieces of the doors of the doors 41a or 41b is two (2) in the present embodiment, but a door having four (4) pieces of doors can be also applied to the doors 41a and 41b, in the similar manner.

Further other embodiment of the elevator apparatus, according to the present invention, will be shown in FIG. 10. The difference of the present embodiment from that shown in FIG. 8 lies in that the pulleys are omitted, which are provided on the top surface of the elevator cars. Though not shown in the figure, also the pulleys are omitted on the counterweight side. This is preferable to a building, which has a space in the machine room, relatively, and therefore the motors 3a and 3b can be large-sized. Comparing to the embodiment shown in FIG. 8, the motors 3a and 3b increase the volume thereof, since the rotation speed comes down to a half (½) and the torque come up to two-times large (x2), but the roping structure is simple, and therefore it is possible to narrow the distance between the elevator cars 1a and 1b.

In this FIG. 10, it is also possible to provide a pulley on the counterweigh side, thereby bringing an amount of elevation of the counterweights 2a and 2b to be a half (½) of that of the elevator cars 1a and 1b. For example, the two (2) pieces of the counterweights 2a and 2b are elevated only in a lower portion below a half of the total elevating region of the elevator cars 1a and 1b. With this, a space can be defined in an upper portion of the elevating passage 54, by the width of the two (2) sets of the counterweights. If providing an electric power unit and/or a control panel not shown in the figure in this space, freedom can be increased in disposing the equipments, and it is possible to save the space for the elevator apparatus. Also, since the elevation amount come down to a half (½) on the counterweights 2a and 2b, it is sufficient to provide the counterweight rails 15 (see FIG. 10) only in the lower side half of the elevating passage 54. According to the present embodiment, with parallel provision of the counterweights 2a and 2b in front and behind, the rails can be formed in one body or can be reduced down to a half (½) in the length thereof, therefore it is possible to shorten the time necessary for installing the rails, greatly.

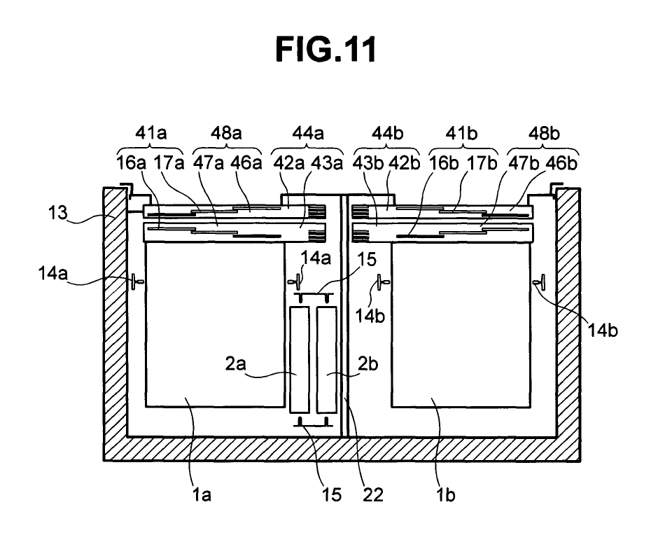

Further other embodiment of the elevator apparatus will be shown in FIG. 11, according to the present invention. The feature of the present embodiment, differing from that shown in FIG. 10 mentioned above, lies in that the elevator A and the elevator B are positioned to be almost same to each other on at the front surfaces thereof, and the counterweights are disposed between the two (2) sets of the elevators. Since the elevator A and the elevator B are same at the front surface position, the elevator cars 1a and 1b are positioned lying up to the vicinity of the wall surface on the rear side of the elevating passage 54. Without shifting the positions of the elevator cars 1a and 1b in front and behind, it is possible to dispose the plural number of the counterweights 2a and 2b in one (1) place, thereby enabling to form the rails for the two (2) sets into a pair of rails 15, in one body.

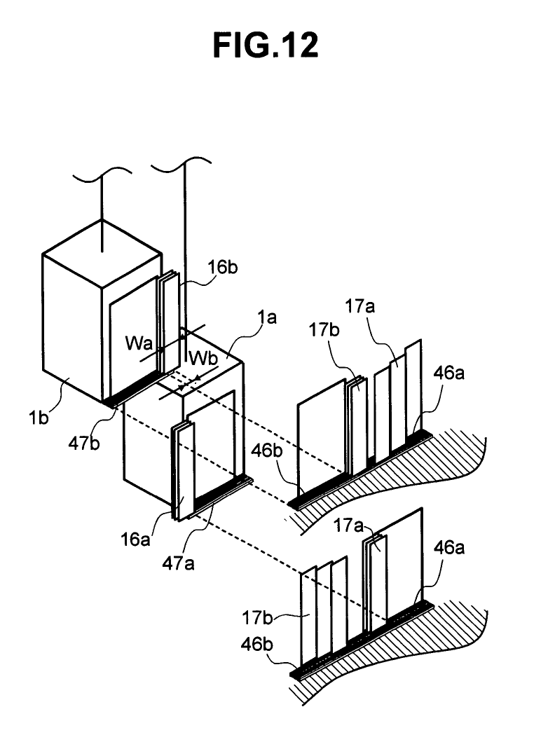

Further other embodiment of the elevator apparatus will be shown, by referring to FIG. 2 and FIG. 12, according to the present invention. FIG. 12 is a perspective view for explaining opening and closing of the doors. In the similar manner to that shown in FIG. 11, the elevator A and the elevator B are same at the front surface position thereof. However, differing from that shown in FIG. 11, the door cases 43a and 43b of the doors 41a and 41b, in the present embodiment, are made short in the distance therebetween, and they are built up, so that when one of the juxtaposing elevators is opening the door thereof, the other elevator car will not be on the same floor; i.e., the door of the other elevator will not open. And, when the door of the elevator A opens, the door case 43a on the elevator car side holds the door 16a at the portion thereof, thereby projecting the remaining portion of the door into the space of the elevating passage in a cantilever-like manner. In this instance, though also the door 17a on the hall side tries to open at the same time, however the door 17a is held under the condition that it projects a portion thereof into the guide groove on the side of the elevator B. It is also similar when the elevator B opens the door 42b.

FIG. 12 shows the details thereof. Herein, it is assumed that the width of the doors 41a and 41b is “Wa”. And, the length “Wb” of the door cases 43a and 43b is made to be shorter than the door width “Wa”. Thus, the doors 41a or 41b protrude into a side of the other elevator by the difference between the door width “Wa” and the door case length “Wb”. With this, it is possible to make the distance “L”short between the two (2) sets of the elevator cars. However, a sum of the lengths “Wb ”s of the respective door cases 43a and 43b is necessary to be larger than the width “Wa” of the door 41a or 41b, and the distance “L” between the elevator cars must be longer than the sum of the lengths “Wb”s of the respective door cases 43a and 43b. However, in the present embodiment, when the doors 41a and 41b come up or down to the same floor, thereby trying to open the doors 41a and 41b, the doors 41a and 41b interfere with each other. Then, operation is so controlled that the juxtaposing elevator cars stop at the different floors always.

According to the present embodiment, since the doors 17a and 17b on the hall side of the juxtaposing elevators are guided by means of one (1) piece of the door guidance groove 46, the guidance grooves 42a and 42b (see FIG. 11) can be formed into a part of one body, therefore it is possible to shorten an installation time for the door guidance groove 46. Further, when two (2) sets of the elevator cars stop at the same floor at the same time, after completion of opening-closing operation of the door on the one elevator car 1a, the opening-closing operation is started on the other elevator car 1b. Or, alternately, they are avoided from interfering with each other, by interconnecting the time for initiating the opening operation of the door 41a on the one elevator car 1a and the time for initiating the closing operation of the door 41b on the other elevator car 1b, so that they can operate at the same timing. However, in each of those embodiments mentioned above, it is also possible to be applied into a case where the elevators are installed in the number of three (3) or more than that.

The elevator apparatus, according to each of the embodiments mentioned above, is also effective when it is retrofitted into the existing elevating passage. It is possible to maximize the area of the elevator cars, in particular, when two (2) elevator cars, each being for four (4) passengers, are installed within the same elevating passage, in the place of the existing elevator car for a large number of passengers, for example.

As was mentioned in the above, according to the present invention, since the hoist of at least one of the juxtaposing elevators is protruded above the other elevator car, it is possible to reduce an area necessary for the elevating passage. Also, since the dispositions of a plural number of elevators, which are installed juxtaposing with each other, are shifted in the direction of front and behind, or since the position of the door for opening/closing is projected into the side of the other elevator when opening, it is possible to reduce the size of width of the elevating passage. Further, it is also possible to reduce the area necessary for installing the elevators therein.

The present invention may be embodied in other specific forms without departing from the spirit or essential feature or characteristics thereof. The present embodiment(s) is/are therefore to be considered in all respects as illustrative and not restrictive, the scope of the invention being indicated by the appended claims rather than by the forgoing description and range of equivalency of the claims are therefore to be embraces therein.

What is claim d is:

1. An elevator apparatus, comprising:
a plural number of elevators, being disposed juxtaposing with each other, each of said elevator having,
an elevator car, and
a hoist, being connected to said elevator car through a rope, wherein the hoist of one of said elevators is protruded above the elevator car of the other elevator.

2. An elevator apparatus, comprising:
a plural number of elevators, being disposed juxtaposing with each other, each of said elevator having,
an elevator car,
a hoist,
a rope, and
a counterweight, wherein a perpendicular projection of the hoist of one of said elevators has a portion overlapping on a perpendicular projection of the elevator car of the other elevator.

3. An elevator apparatus, as described in the claim 1, wherein each of said hoists has a sheave, a motor and a brake, and the motor or the brake of the one elevator projects above the elevator car of the other elevator.

4. An elevator apparatus, as described in the claim 2, wherein each of said hoists has a sheave, a motor and a brake, and a perpendicular projection of the motor or the brake of the hoist owned by the one elevator has a portion overlapping the perpendicular projection of the elevator car owned by the other elevator.

5. An elevator apparatus, as described in the claim 2, further comprising a hall side door guidance groove for letting the opening/closing door of the one elevator to project into a side of the other elevator when the open/close door is opened.

6. An elevator apparatus, as described in the claim 4, wherein a plural number of elevators are positioned within one (1) piece of an elevating passage, and a protection fence for dividing each of the elevators is provided within this elevating passage.

7. An elevator apparatus, as described in the claim 1, wherein two (2) sets of elevators are disposed within one (1) piece of elevating passage, and each of the elevators is that for four (4) passengers.

8. An elevator apparatus, as described in the claim 7, further comprising a controller means for enabling said elevators to operate independently.

9. An elevator apparatus, as described in the claim 1, wherein each of said elevators has an open/close door on a front surface side thereof for a passenger to get on/off, and the elevators are juxtaposed with each other on a rear side thereof.

10. An elevator apparatus, as described in the claim 7, wherein each of said elevators has an open/close door on a front surface side there of for a passenger to get on/off, and the elevators are arranged on a line with front surface sides thereof, each having the door.

11. An elevator apparatus, providing a plural number of elevators juxtaposing with each other within an elevating passage, wherein positions of an open/close door portion of one of the elevators and an open/close door portion of the other of the elevators are shifted in front and behind each other.

12. An elevator apparatus, as described in the claim 11, wherein a guide rails are disposed on a rear surface of the elevator, having the open-close door portion in front, for allowing counterweights of the plural number of elevators to elevate.

13. An elevator apparatus, as described in the claim 11, wherein between the one elevator and the other elevator door, cases for receiving the open/close doors therein are disposed to overlap with each other in front and behind.

14. An elevator apparatus, as described in the claim 12, wherein a pulley is provide on each of said counterweights, on which a rope for allowing the counterweight to elevate is suspended, and a controller means is provided in an upper portion of the elevating passage, in which the counterweight elevates.

15. An elevator apparatus, having a plural number of elevators provided juxtaposing with each other within an elevating passage, each elevator having an elevator car and a hoist, which is connected to the elevator car through a rope, wherein the hoist of one elevator projects above the elevator car of the other elevator, and comprising a hall side door guidance groove for allowing an open/close door of the one elevator to project to a side of the other elevator when said open/close door opens.

16. An elevator apparatus, as described in the claim 15, wherein rails are provided in a space defined between the plural numbers of elevator cars, on which the counterweights of the plural number of the elevators elevate.

17. An elevator apparatus, as described in the claim 15, wherein a guidance length of a door case for receiving said open/close door therein of the elevator car side is shorter than a door width of said open/close door.

18. An elevator apparatus, as described in the claim 15, wherein said hall side door guidance groove can be used in common with the juxtaposing elevators.

19. An elevator apparatus, as described in the claim 15, further comprising a controller means for controlling, so that when stopping one of two (2) sets of elevators juxtaposing with each other among said plural numbers of elevators, the other elevator stops a floor different therefrom.

20. An elevator apparatus, as described in the claim 15, further comprising a controller means for controlling, so that when stopping two (2) sets of juxtaposing elevators among said plural numbers of elevators at a same floor, while an open/close door of the one elevator opens, an open/close door of the other elevator is kept to close.
